(19) United States
(12) Patent Application Publication
(10) Pub. No.: US 2005/0275130 A1
(43) Pub. Date: Dec. 15, 2005

(54) Logo forming method and the device for the same

(75) Inventors: Kuang-Hui Su, Sanchung City (TW); Tse-Hui Lei, Sanchung City (TW)

Correspondence Address: BACON & THOMAS, PLLC, 625 SLATERS LANE, FOURTH FLOOR, ALEXANDRIA, VA, 22314, US

(73) Assignee: Universal Sporting Goods (Thai) Co., Ltd., Samphan Nakornpathom (TH)

(21) Appl. No.: 10/852,147

(22) Filed: May 25, 2004

(51) Int. Cl. B29C 59/02

(52) U.S. Cl. 264/163; 425/299

(57) ABSTRACT

A method for making an image on a base layer includes preparing a substrate, placing an exterior layer on top of the substrate, preparing a cutting mold, cutting the exterior layer with a predetermined shape, and hot pressing the exterior layer on the substrate by the cutting mold. The cutting mold has a body, a cutting edge formed with the body and extending out from the body for cutting a portion of an exterior layer on top of the base layer, a pressing surface formed adjacent to the cutting edge for pressing an outer contour of a remaining portion of the exterior layer onto the base layer, and a space defined immediately adjacent to the pressing surface and having a shape the same as that of the image.

### BACKGROUND OF THE INVENTION

1. Field of the Invention

The present invention relates to a method for forming a logo on a substrate and the device for the same, and more particularly to the method which uses a cutting mold to cut off an exterior layer and form the cut-off exterior layer on a substrate by hot pressing sequentially.

2. Description of Related Art

Normally, when an image such as a logo is to be formed on a substrate, the operator first prepares an image of an appropriate dimension. Then after the image is pasted on a substrate, a mold is prepared to form the image on the substrate by hot pressing.

Another different conventional method is to directly form an image on the substrate when the substrate is prepared. Then the operator paints a color directly onto the image to enhance the appearance of the substrate.

Neither of the aforementioned methods can finish forming the logo quickly, nor can they be performed economically because different manual steps are involved to shift the semi-product around in the plant to proceed the next steps.

To overcome the shortcomings, the present invention tends to provide an improved method and device to mitigate the aforementioned problems.

### SUMMARY OF THE INVENTION

The primary objective of the present invention is to provide an improved method for forming an image on a substrate, which includes the following steps:

preparing a substrate;

placing an exterior layer on top of the substrate;

preparing a cutting mold;

cutting the exterior layer with a predetermined shape; and

hot pressing the exterior layer on the substrate by the cutting mold.

Another objective of the present invention is to provide a cutting mold for forming an image on top of the substrate. The cutting mold is provided with a tapered cutting edge and a pressing surface formed adjacent to the cutting edge such that after the exterior layer is cut off by the cutting edge to have a specific shape, the pressing surface is able to securely form the cut off exterior layer on the substrate by hot pressing.

Other objects, advantages and novel features of the invention will become more apparent from the following detailed description when taken in conjunction with the accompanying drawings.

### BRIEF DESCRIPTION OF THE DRAWINGS

FIG. 1 is a cross sectional view showing the cutting mold of the present invention;

FIG. 1A is a bottom plan view showing the contour of the cutting mold of the present invention;

FIG. 2 is a schematic view showing that the exterior layer is placed on top of the substrate and the cutting mold is about to cut the exterior layer;

FIG. 3 is a schematic view showing the cutting mold is cutting the exterior layer;

FIG. 4 is a schematic view showing that the exterior layer is cut by the cutting mold to have a specific shape and the exterior layer is then hot pressed onto the substrate by the pressing surface of the cutting mold; and

FIG. 5 is a perspective view showing that an image is formed on the substrate by the method and the cutting mold of the present invention.

### DETAILED DESCRIPTION OF THE PREFERRED EMBODIMENT

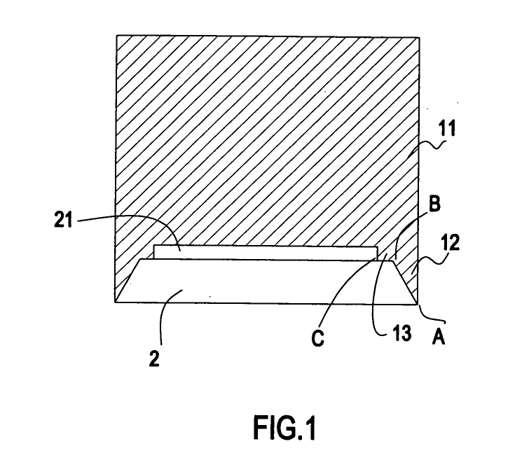

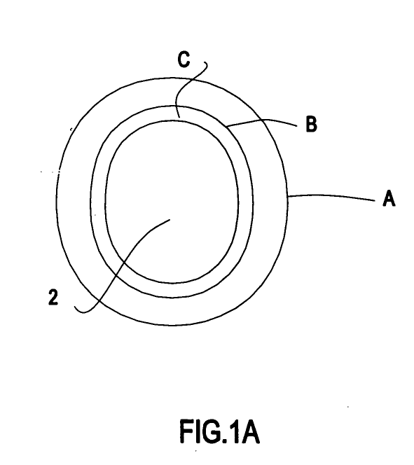

With reference to FIGS. 1, 1A and 2, it is noted that a cutting mold (1) in accordance with the present invention has a body (11), a tapered cutting edge (12) formed on an outer end side of the body (11) and a pressing surface (13) formed adjacent to the cutting edge (12). In order to have a better understanding of the structure of the cutting mold (1), a distal point of the cutting edge (12) is designated with a reference letter (A), a point between the cutting edge (12) and the pressing surface (13) is designated with a reference letter (B), and a free point of the pressing surface (13) is designated with a reference letter (C). Therefore, an obtuse triangle is formed by the three points (A,B,C). A first space (2) is defined and enclosed by the cutting edge (12) and a second space (21) in communication with the first space (2) is defined inside the body of the cutting mold (1).

With reference to FIG. 2, it is noted that a base layer (3), e.g. a basketball skin, is prepared. Then an exterior layer (4) is placed on top of the base layer (3). The cutting mold (1) of the present invention is placed on top of the exterior layer (4). Although the exterior layer (4) is shown to have a dimension smaller than the dimension of the base layer (3), it is not necessary to have this limitation. However, because only a portion of the exterior layer (4) is required for the image making, the smaller the dimension of the exterior layer (4) is, the better.

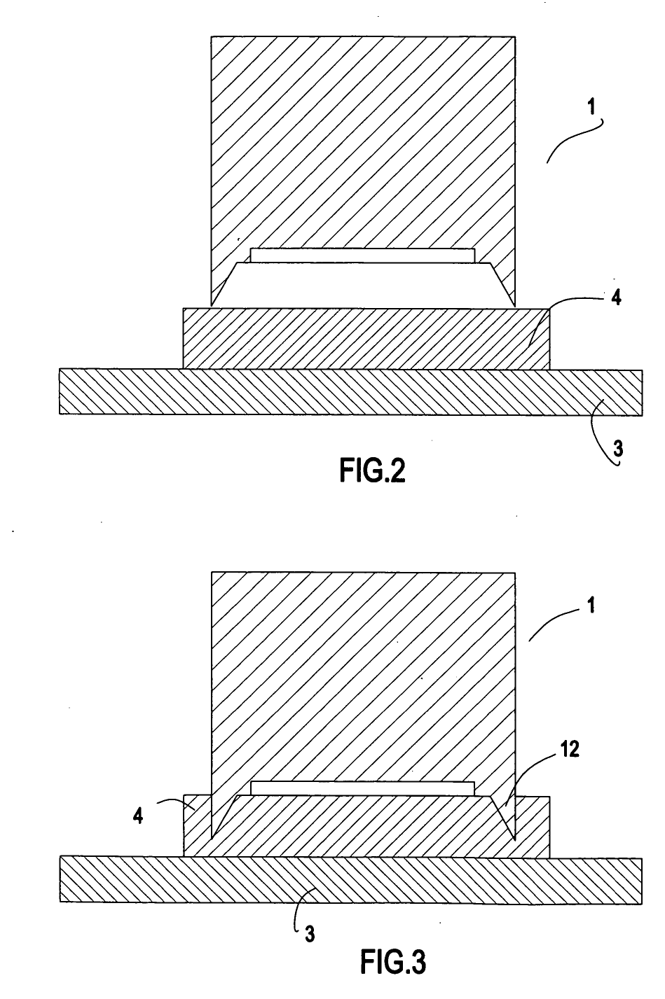

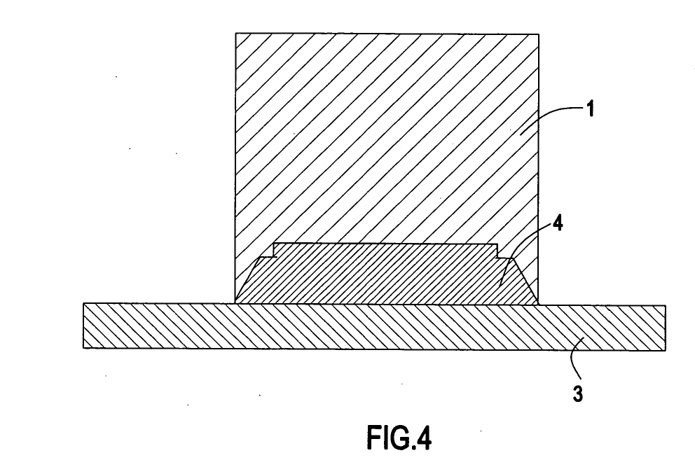

With reference to FIGS. 3 and 4, the cutting mold (1) is forced downward to the exterior layer (4) to cut away an unnecessary portion of the exterior layer (4). After the exterior layer (4) is cut, the pressing surface (13) of the cutting mold (1) presses an outer contour (41) of the remaining exterior layer (4). Because the pressing surface (13) is preheated, the pressing operation of the pressing surface (13) to the exterior layer (13) securely combines the remaining exterior layer (4) and the base layer (4). Thus it is seen that the outer contour of the remaining exterior layer (4) is received in the first space (2) and the central portion of the remaining exterior layer (4) is received in the second space (21).

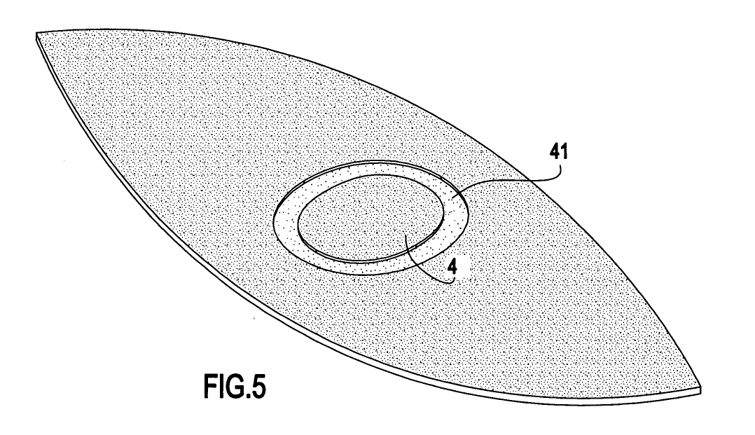

With reference to FIG. 5, it is noted that the remaining exterior layer (4) has a shape the same as that of the space (2) of the cutting mold (1), and the outer contour (41) of the remaining exterior layer (4) has a width the same as that of the pressing surface (13) of the cutting mold (1).

Therefore, the operator is able to use the cutting mold (1) of the present invention to make an image and then combine the image and the base layer (3) sequentially.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A cutting mold for making an image on a base layer, the cutting mold comprising:
a body;
a cutting edge formed with the body and extending out from the body for cutting a portion of an exterior layer on top of the base layer;
a pressing surface formed adjacent to the cutting edge for pressing an outer contour of a remaining portion of the exterior layer onto the base layer; and
a space defined immediately adjacent to the pressing surface and having a shape the same as that of the image.

2. The cutting mold as claimed in claim 1, wherein the cutting edge is tapered.

3. The cutting mold as claimed in claim 2, wherein three points, a distal end of the cutting edge, a joint between the cutting edge and the pressing surface and a distal end of the pressing surface form an obtuse triangle.

4. The cutting mold as claimed in claim 3 further having a second space in communication with the first space and defined in the body.

5. A method for making an image on a base layer, the method comprising the steps of:
preparing a substrate;
placing an exterior layer on top of the substrate;
preparing a cutting mold;
cutting the exterior layer with a predetermined shape; and
hot pressing the exterior layer on the substrate by the cutting mold.

6. The method as claimed in claim 5, wherein the cutting mold comprises:
a body;
a cutting edge formed with the body and extending out from the body for cutting a portion of an exterior layer on top of the base layer;
a pressing surface formed adjacent to the cutting edge for pressing an outer contour of a remaining portion of the exterior layer onto the base layer; and
a space defined immediately adjacent to the pressing surface and having a shape the same as that of the image.

7. The cutting mold as claimed in claim 6, wherein the cutting edge is tapered.

8. The cutting mold as claimed in claim 7, wherein three points, a distal end of the cutting edge, a joint between the cutting edge and the pressing surface and a distal end of the pressing surface form an obtuse triangle.
